(19) United States
(12) Patent Application Publication
(10) Pub. No.: US 2026/0289067 A1
(43) Pub. Date: Sep. 24, 2026

(54) COMPUTER PROGRAM, INFORMATION PROCESSING APPARATUS, AND INFORMATION PROCESSING METHOD

(71) Applicant: Tokyo Electron Limited, Tokyo (JP)

(72) Inventors: Dai KOBAYASHI, Sapporo City (JP); Jun SHINAGAWA, Fremont, CA (US)

(73) Assignee: Tokyo Electron Limited, Tokyo (JP)

(21) Appl. No.: 19/670,057

(22) Filed: May 7, 2026

Related U.S. Application Data
(63) Continuation of application No. PCT/JP2024/039400, filed on Nov. 6, 2024.

(30) Foreign Application Priority Data
Nov. 20, 2023 (JP) 2023-196985

(51) Int. Cl. G06F 30/398; G06F 119/18

(52) U.S. Cl. CPC G06F 30/398; G06F 2119/18

(57) ABSTRACT

A non-transitory computer-readable medium stores executable instructions, which when executed by circuitry, cause the circuitry to perform a method. The method includes acquiring observed data corresponding to a plurality of types of observation variables from an observation system; setting a pre-constraint based on a causal structure of a variable group in a reference system; and deriving a causal structure of an observation variable group in the observation system by executing training in which the prior constraint is imposed, using the acquired observed data.

### CROSS-REFERENCE TO RELATED APPLICATIONS

This application is a bypass continuation application of International Application No. PCT/JP2024/039400 having an international filing date of Nov. 6, 2024 and designating the United States, the international application being based upon and claiming the benefit of priority from Japanese Patent Application No. 2023-196985, filed on Nov. 20, 2023, the entire contents of each of which are incorporated herein by reference.

### BACKGROUND

### Field

The disclosure relates to a computer program, an information processing apparatus, and an information processing method.

### Background Art

In a substrate processing apparatus, processing is performed on a substrate based on a recipe of a process. The recipe is implemented by a plurality of steps, and for example, by controlling various parameters such as a pressure and a temperature for each step, an optimal processing result can be obtained. Since set values of the various parameters may differ for each step, measurement data of a plurality of sensors provided in the substrate processing apparatus are managed for each substrate.

PTL 1 discloses a technique for visualizing data with respect to a process having multiple-dimensional independent variables and dependent variables.

### Citation List

### Patent Documents

PTL 1: JP2022-502806A

### SUMMARY

In an embodiment of the disclosure, a non-transitory computer-readable medium stores executable instructions, which when executed by circuitry, cause the circuitry to perform a method. The method includes acquiring observed data corresponding to a plurality of types of observation variables from an observation system; setting a pre-constraint based on a causal structure of a variable group in a reference system; and deriving a causal structure of an observation variable group in the observation system by executing training in which the prior constraint is imposed, using the acquired observed data.

### BRIEF DESCRIPTION OF DRAWINGS

The scope of the present disclosure is best understood from the following detailed description of exemplary embodiments when read in conjunction with the accompanying drawings.

FIG. 1 is an illustrative diagram illustrating a configuration of an information processing system according to an embodiment.

FIG. 2 is a block diagram illustrating an internal configuration of an information processing apparatus.

FIG. 3 is an illustrative diagram illustrating an internal representation of a causal structure.

FIG. 4 is an illustrative diagram illustrating an example of setting a confidence interval.

FIG. 5 is a schematic diagram illustrating an example of the causal structure that has nonlinearity.

FIG. 6 is an illustrative diagram illustrating an example of the causal structure obtained by performing additional training based on a general-purpose structure.

FIG. 7 is a flowchart illustrating a procedure for deriving the causal structure using the general-purpose structure.

FIG. 8 is a schematic diagram illustrating an example of displaying the causal structure obtained through the additional training.

FIG. 9 is a schematic diagram illustrating an example of the causal structure when a disturbance factor is generated.

FIG. 10 is a flowchart illustrating a procedure for estimating an unknown disturbance.

### DETAILED DESCRIPTION

Hereinafter, an embodiment will be described with reference to the drawings.

### Embodiment 1

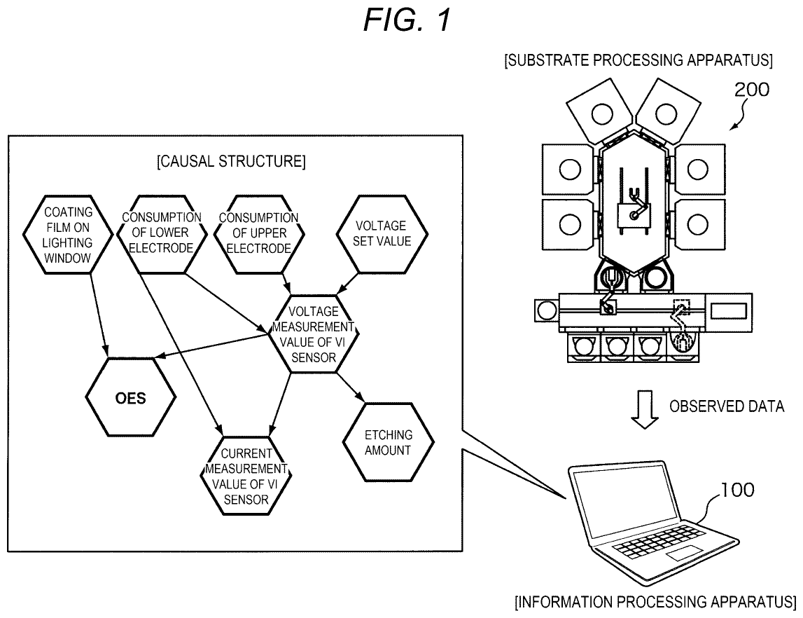

FIG. 1 is an illustrative diagram illustrating a configuration an information processing system according to an embodiment. The information processing system according to the embodiment includes an information processing apparatus 100 and a substrate processing apparatus 200 communicably connected to each other.

The substrate processing apparatus 200 is, for example, a semiconductor manufacturing apparatus that includes at least one of an exposure apparatus, an etching apparatus, a film forming apparatus (layer forming apparatus), an ion implantation apparatus, an ashing apparatus, a sputtering apparatus, and the like. Alternatively, the substrate processing apparatus 200 may be a display manufacturing apparatus that manufactures a flat display panel (FDP) such as a liquid crystal display panel or an organic electro-luminescence (EL) panel.

Various set values for a temperature of a substrate, a pressure or a gas flow rate in a chamber, a voltage applied from a radio-frequency power supply, and the like are set in the substrate processing apparatus 200 at the start of a process. Further, the substrate processing apparatus 200 includes a plurality of sensors that measure the temperature of the substrate, the pressure or the gas flow rate in the chamber, a voltage applied to an upper electrode or a lower electrode, and the like, during the execution of the process. The substrate processing apparatus 200 outputs, to the information processing apparatus 100, set values set at the start of the process and measurement values measured during the execution of the process as observed data.

The information processing apparatus 100 acquires observed data corresponding to a plurality of types of observation variables from the substrate processing apparatus 200 of the observation system. The information processing apparatus 100 sets pre-constraints based on a causal structure of a reference system, and uses the observed data obtained from the substrate processing apparatus 200 of the observation system to execute training in which the prior constraint is imposed, thereby deriving the causal structure of the observation variable group in the observation system. In the embodiment, the observation system and the reference system are the same type of the substrate processing apparatus 200. As the causal structure of the reference system, for example, a causal structure generated in advance based on the knowledge of the user can be used. Alternatively, the causal structure of the reference system may be a causal structure generated based on the observed data obtained from the specific substrate processing apparatus 200.

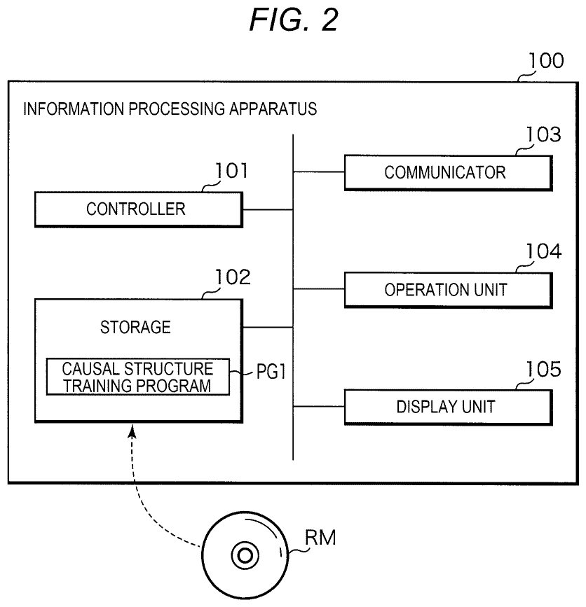

FIG. 2 is a block diagram illustrating an internal configuration of the information processing apparatus 100. The information processing apparatus 100 is, for example, a dedicated or general-purpose computer including a controller 101 (herein “controller” means the same as “controller circuitry”), a storage 102, a communicator 103, an operator 104, and a display 105.

The controller 101 includes a central processing unit (CPU), a read only memory (ROM), a random access memory (RAM), and the like (i.e., non-transitory computer-readable medium/mediums). The ROM provided in the controller 101 stores control programs and the like for controlling the operation of each component of the hardware provided in the information processing apparatus 100. The CPU in the controller 101 reads and executes control programs stored in the ROM and computer programs stored in the storage 102 to be described later, and controls the operation of each component of the hardware, and thus causes the entire apparatus to function as the information processing apparatus of the present disclosure. The RAM provided in the controller 101 temporarily stores data used during the execution of an arithmetic operation.

In the embodiment, although the controller 101 includes the CPU, the ROM, and the RAM, the configuration of the controller 101 is not limited to the above-described configuration. The controller 101 may be, for example, one or a plurality of control circuits or arithmetic circuits that include a graphics processing unit (GPU), a field programmable gate array (FPGA), a digital signal processor (DSP), a quantum processor, a volatile or nonvolatile memory, or the like. In addition, the controller 101 may include functions such as a clock for outputting date and time information, a timer for measuring the time elapsed from the time when a measurement start instruction is applied to the time when a measurement end instruction is applied, and a counter for counting the number. The controller/controller circuitry 101 can be programmable circuitry (e.g., embedded processor) or fixed circuitry (e.g., ASIC or PAL). In an exemplary embodiment, the controller/controller circuitry 101 can include one or more programmable processors/controllers.

The storage 102 includes storage devices such as a hard disk drive (HDD), a solid state drive (SSD), and an electronically erasable programmable read only memory (EEPROM). The storage 102 stores various types of computer programs executed by the controller 101 and various data used by the controller 101.

The computer program (program product) stored in the storage 102 includes a causal structure training program PG1 for causing the computer to execute processing of deriving the causal structure of the observation variable based on the observed data of the substrate processing apparatus 200. The causal structure training program PG1 may be a single computer program or may be implemented by a plurality of computer programs. The causal structure training program PG1 may be executed by a plurality of computers in cooperation with each other. Further, the causal structure training program PG1 may partially use an existing library.

The computer program that includes the causal structure training program PG1 is provided by a non-temporary recording medium RM on which the computer program is recorded in a readable manner. The recording medium RM is a portable memory such as a CD-ROM, a USB memory, a secure digital (SD) card, a micro SD card, or a compact flash (registered trademark). The controller 101 reads various types of computer programs from the recording medium RM using a reading device and stores the read various types of computer programs in the storage 102. In addition, the computer program stored in the storage 102 may be provided through communication. In this case, the controller 101 may acquire the computer program through communication via the communicator 103, and may store the acquired computer program in the storage 102.

The communicator 103 includes a communication interface for transmitting and receiving various types of data to and from an external apparatus. As the communication interface of the communicator 103, a communication interface conforming to a communication standard such as a local area network (LAN) can be used. The external apparatus includes the substrate processing apparatus 200 and a user terminal. When data to be transmitted is input from the controller 101, the communicator 103 transmits the data to the external apparatus that is a destination, and outputs the received data to the controller 101 when the data transmitted from the external apparatus is received.

The operator 104 includes operating devices such as a touch panel, a keyboard, and switches, and receives various types of operations and settings by the user or the like. The controller 101 performs appropriate controls based on various operation information supplied by the operator 104, and causes the storage 102 to store setting information as necessary.

The display 105 includes a display device such as a liquid crystal monitor or an organic electro-luminescence (EL), and displays information to be notified to the user or the like in response to an instruction from the controller 101.

In the embodiment, the information processing apparatus 100 may be a single computer or may be a computer system including a plurality of computers, peripheral devices, and the like. In addition, the information processing apparatus 100 may be a virtual machine in which entities are virtualized, or may be a cloud. Further, although the information processing apparatus 100 and the substrate processing apparatus 200 are described as being separate from each other in the embodiment, the information processing apparatus 100 may be provided inside the substrate processing apparatus 200.

Hereinafter, the causal structure generated by the information processing apparatus 100 will be described.

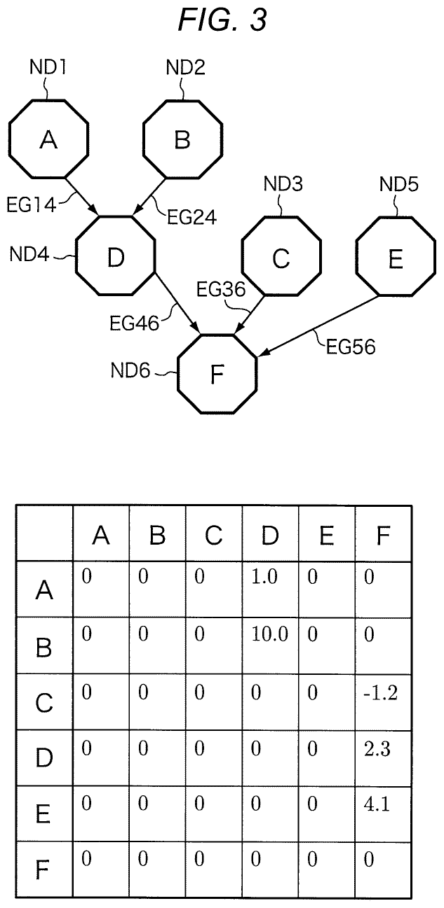

FIG. 3 is an illustrative diagram illustrating an internal representation of the causal structure. The causal structure is drawn by, for example, a directed acyclic graph using nodes representing the observation variables and edges representing causal relationships between the nodes. The upper part of FIG. 3 represents the causal structure drawn by the directed acyclic graph, and the lower part of FIG. 3 represents the internal representation thereof.

The causal relationship between the observation variables can be modeled by a structural equation model. In a linear non-Gaussian acyclic model (LiNGAM), which is one of the structural equation models, a linear acyclic model is used, and a probability distribution of an exogenous variable (an error variable) is assumed to be a non-Gaussian distribution.

A DirectLiNGAM algorithm has been proposed as one of the algorithms (causal search algorithms) for searching for the structural equation model (see, for example, S. Shimizu et al. Journal of Machine Learning Research, 12(Apr): 1225-1248 (2011)). In this algorithm, a coefficient (a weight of an edge) of linear regression can be optimized by repeating regression analysis and an evaluation for independence between regression residuals based on the above assumption. The directed acyclic graph can be drawn by drawing the edge between the nodes based on the optimized coefficient of the linear regression.

In the causal search, edges may be drawn from a plurality of other nodes with respect to one node unless an edge circulates. In order to avoid such an over-training state, a constraint condition that prohibits an edge from being drawn from a plurality of observation variables having collinearity to one observation variable at the same time may be added.

The observation variables may include set values such as apparatus recipes for designating an execution content of a process, measurement values of various sensors measured along with the execution of the process, observation values or measurement values related to the state of the substrate processing apparatus 200 or the degree of consumption of parts, and observation values or measurement values indicating the quality of the substrate processing. The substrate processing apparatus 200 can acquire, as observation variables, set values designated by a control device of the substrate processing apparatus 200 itself, observation values or measurement values obtained from various sensors or measurement apparatuses provided in the substrate processing apparatus 200 itself, observation values or measurement values obtained from measurement apparatuses provided outside the substrate processing apparatus 200 itself, and the like. For example, in an actual process in the substrate processing apparatus 200, various set values and observation values such as a coating layer on a lighting window, an optical emission spectrometer (OES), a consumption of the lower electrode, a consumption of the upper electrode, a voltage set value, a voltage measurement value of a VI sensor, a current measurement value of the VI sensor, and an etching amount can be handled as observation variables. In the example of FIG. 3, six observation variables are extracted for the sake of simplicity, and only a causal relationship among the six extracted observation variables is illustrated.

The directed acyclic graph (causal structure) illustrated in the upper part of FIG. 3 is implemented by nodes ND1 to ND6 corresponding to the six observation variables (observation variables A to F), and a plurality of edges EG14, EG24, EG36, EG46, and EG56 representing the causal relationship among the observation variables (among the nodes). In the example of FIG. 3, the nodes ND1 to ND6 are illustrated by icons having a regular octagon. However, the shape of the icons is not limited to a regular octagon, and may be a circle or any other shape. In the example of FIG. 3, character strings illustrated inside the icons represent variable names of the observation variables.

In the example of FIG. 3, the edge EG14 that connects the node ND1 and the node ND4 is drawn. The edge EG14 represents a causal relationship between the observation variable (the observation variable A) corresponding to the node ND1 and the observation variable (the observation variable D) corresponding to the node ND4. The edge EG14 is drawn from the node ND1 toward the node ND4, and thus indicates that the observation variable A affects the observation variable D. The same applies to the causal relationship between other observation variables.

The directed acyclic graph can be represented by a matrix. In FIG. 3, matrix elements of the corresponding matrix are illustrated by a chart, together with the directed acyclic graph representing the causal structure described above. In this chart, a value of the matrix element indicates whether an edge exists, the value of 0 indicates that an edge does not exist, and the value other than 0 indicates that an edge exists. For example, since the matrix element in the first row and the fourth column has a value of 1.0, it indicates that there is an edge from the node of the observation variable A represented by the index in the first row toward the node of the observation variable D represented by the index in the fourth column. Since the matrix elements other than the fourth column in the first row contain a value of 0, it indicates that there are no edges from the node of the observation variable A toward the observation variables B, C, E, and F. The same applies to the second to sixth rows.

The value of the matrix element represents the weight of the edge (the strength of the connection between the nodes), and is calculated as the coefficient of the linear regression in the DirectLiNGAM algorithm, for example. In the directed acyclic graph, the weight of the edge may be represented. For example, a numerical value representing the weight of the edge may be illustrated on the graph, and a thickness (line thickness) and a color of the edge may be changed according to the weight of the edge.

As illustrated in the example of FIG. 3, the weight of the edge may have a negative value. When the weight of the edge is a negative value, it indicates that the relationship between the nodes is a negative correlation. That is, it represents the relationship in which the observation variable on the end point side changes in a negative direction when the observation variable on the start point side changes in a positive direction. In the example of FIG. 3, a matrix element in the third row and the sixth column has a negative value of −1.2. Therefore, when the observation variable C (the observation variable on the start point side) is changed in the positive direction, the observation variable F (the observation variable on the end point side) changes in the negative direction. The matrix element in the third row and the sixth column represents the edge from the node of the observation variable C toward the node of the observation variable F, and does not represent the edge from the node of the observation variable F toward the node of the observation variable C. In the embodiment, it is noted that the direction of the edge does not reverse depending on whether the weight of the edge is a positive value or a negative value.

In the example of FIG. 3, a method of describing the directed acyclic graph by the matrix has been described. However, the directed acyclic graph may be described by an edge list in which the nodes representing the start point and the end point of the edge and the weight of the edge are listed. In either case, the information processing apparatus 100 is described in a list format or an array format.

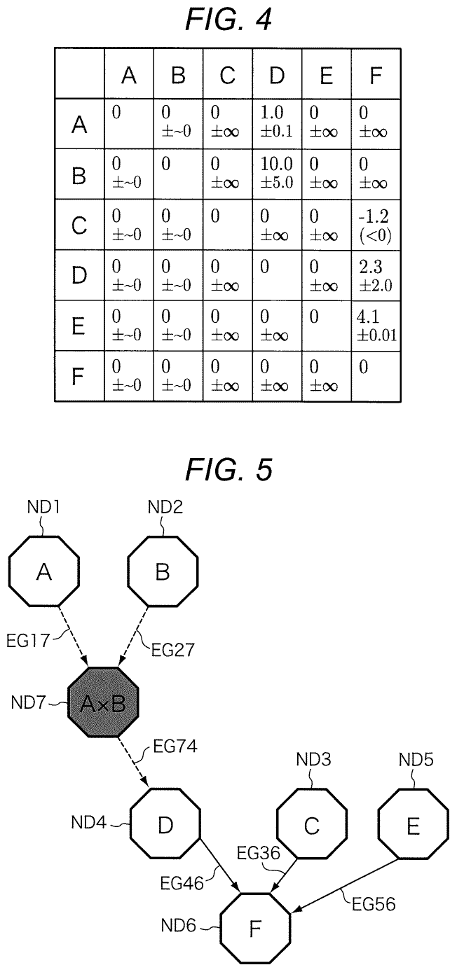

A confidence interval is set for the weight of the edge. The confidence interval is set based on the probability distribution of the exogenous variable (the error variable) calculated during the causal search. FIG. 4 is an illustrative diagram illustrating an example of setting the confidence interval. When it is assumed that the weight of the edge has a probability distribution (for example, a Gaussian distribution) defined by a center value and a width, the confidence interval can be set as a range of ±α (α is a value in a range of 0 to ∞) with respect to the original weight. In the example of FIG. 4, the weight of the edge between the nodes corresponding to the observation variables A and D is 1.0, and a confidence interval of ±0.1 is set for the weight.

The same applies to a case where it is assumed that the weight of the edge has a probability distribution such as a sigmoid distribution, and the confidence interval is set based on the probability distribution of the weight. In the example of FIG. 4, the weight of the edge between the nodes corresponding to the observation variables C and F is −1.2. However, when the value of the weight is set to be at least less than 0 (that is, when a negative value of −0.5 and the like can be obtained through training but does not become a positive value of +1.0 and the like), the confidence interval is set to be less than 0 (referred to as <0 in the drawing).

In the above-described causal search, it is assumed that the relationship between the observation variables is linear. However, a causal structure that has nonlinearity may be searched for. A functional form is unknown. However, since an algorithm capable of searching for nonlinearity is known, the algorithm can be used to search for a causal structure that has nonlinearity. When the causal structure that has nonlinearity is drawn, a node for displaying the functional form may be added between nodes that become nonlinear.

FIG. 5 is a schematic diagram illustrating an example of the causal structure that has nonlinearity. The example of FIG. 5 indicates that there is a nonlinear relationship between the observation variables A and B and the observation variable D, where observation variable D=observation variable A×observation variable B. In this case, a node ND7 for displaying the functional form of A×B is added, and the nodes ND1, ND2, and ND4 and the node ND7 are connected to one another by edges EG17, EG27, and EG74, respectively. In order to distinguish a node of an ordinary observation variable and an ordinary edge between the observation variables, a display aspect may be changed by changing and displaying the color of the node for displaying the functional form or by displaying the edge for connecting the node in a broken line.

In the embodiment, when the causal structure of the reference system is obtained, a pre-constraint is set based on the causal structure of the reference system, and the causal structure of the observation system is derived by executing training in which the prior constraint is imposed, using the observed data obtained from the observation system.

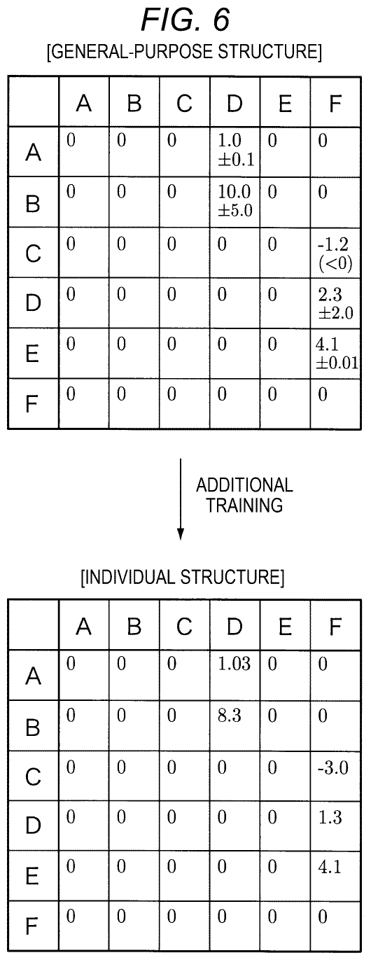

FIG. 6 is an illustrative diagram illustrating an example of the causal structure obtained by performing additional training based on a general-purpose structure. The upper part of FIG. 6 illustrates the general-purpose structure. The general-purpose structure refers to the causal structure of the reference system generated by the knowledge of the user or the causal structure of the reference system derived from observed data of the specific substrate processing apparatus 200. When there is a mechanism understood as the knowledge of the user without needing to collect the observed data, the causal structure generated based on the knowledge of the user can be used as the general-purpose structure. The user can generate the general-purpose structure by drawing an edge connecting the nodes corresponding to the observation variables or the observation variables and giving the weight of the edge (the strength of the connection between the nodes) as a numerical value, using the operator 104 of the information processing apparatus 100.

In a case where there are a plurality of substrate processing apparatuses 200 having similar mechanisms, it is considered that a rough causal structure is common among the apparatuses. Therefore, the causal structure in the specific substrate processing apparatus 200 that is representatively generated can be used as the general-purpose structure. In this case, the information processing apparatus 100 collects the observed data from the specific substrate processing apparatus 200, and can generate the general-purpose structure by using the above-described causal search algorithm.

Further, the causal structure of the reference system generated based on the knowledge of the user may be corrected based on the observed data obtained from the substrate processing apparatus 200 of the reference system, and the corrected causal structure may be used as the general-purpose structure. That is, the weight of the edge set by the user may be used as an initial value, and additional training may be performed based on the observed data actually obtained from the reference system to correct the causal structure generated by the user, and the corrected causal structure may be used as the general-purpose structure.

The general-purpose structure described above is generated in advance, and parameters of the general-purpose structure, including the weight of the edge and the confidence interval (a tolerance of a variation due to a machine difference) for the weight, are stored in the storage 102 of the information processing apparatus 100.

The lower part of FIG. 6 illustrates an individual structure. The individual structure refers to an individual causal structure obtained through the additional training using the general-purpose structure. By acquiring the observed data from the individual substrate processing apparatuses 200 and performing the additional training using the general-purpose structure, the causal structure (individual structure) for the individual apparatuses can be derived. Compared to the case of generating the causal structure from a state where there is no prior knowledge, a data amount of necessary observed data can be reduced, so that the efficiency of training can be improved.

In the embodiment, when the additional training is performed using the general-purpose structure, the weight in the individual structure is adjusted so as not to deviate significantly from a reference value (original weight) by imposing a loss according to the confidence interval. In the example of the general-purpose structure of FIG. 6, the weight of the edge between the observation variables A and D is 1.0, and the confidence interval of the weight is set to ±0.1. Therefore, for example, a weight w of the edge in the individual structure may be adjusted by imposing a loss of abs(1.0−w)/0.1 such that a large loss is imposed on the weight of 1.1 or more or 0.9 or less. In the example between the observation variables A and D, the weight of the edge is 1.0 in the general-purpose structure, whereas the weight is adjusted to 1.03 in the individual structure.

In the example of the general-purpose structure of FIG. 6, the weight of the edge between the observation variables C and F is −1.2, and the confidence interval of the weight is set to be less than the reference value (<0). Therefore, for example, the weight of the edge in the individual structure is adjusted such that a large loss is imposed on the weight that becomes −1.2 or more. In the example between the observation variables C and F, the weight of the edge is −1.2 in the general-purpose structure, whereas the weight is adjusted to −3.0 in the individual structure.

Hereinafter, a procedure for deriving the causal structure using the general-purpose structure will be described.

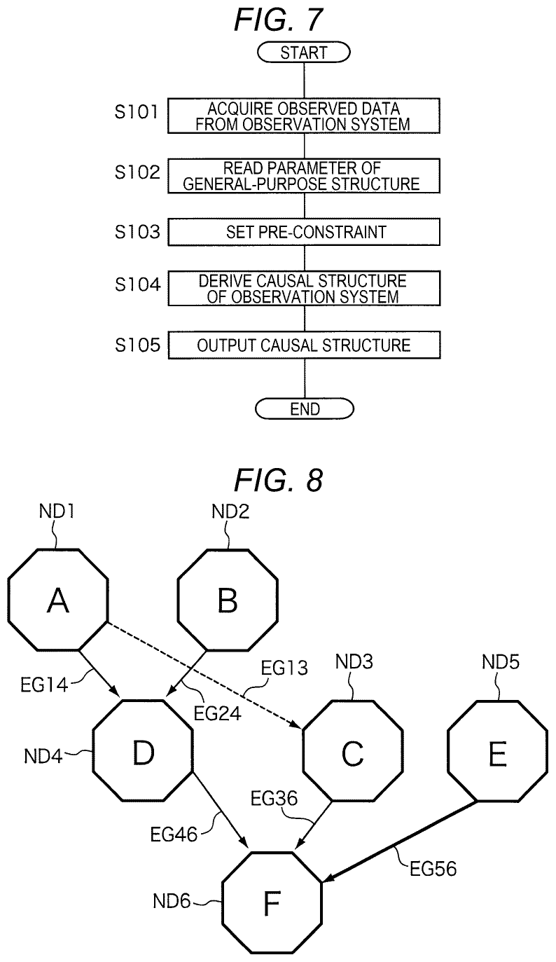

FIG. 7 is a flowchart illustrating the procedure for deriving the causal structure using the general-purpose structure. The controller 101 of the information processing apparatus 100 performs the following processing by reading and executing the causal structure training program PG1 from the storage 102.

The controller 101 acquires the observed data corresponding to the plurality of types of observation variables from the substrate processing apparatus 200 of the observation system (step S101). The observed data acquired by the controller 101 includes data measured by the substrate processing apparatus 200 and data set by the substrate processing apparatus 200, such as the coating layer on the lighting window, the OES, the consumption of the lower electrode, the consumption of the upper electrode, the voltage set value, the voltage measurement value of the VI sensor, the current measurement value of the VI sensor, and the etching amount. The controller 101 communicates with the substrate processing apparatus 200 via the communicator 103 to acquire these types of observed data.

The controller 101 reads the parameters of the general-purpose structure from the storage 102 (step S102). In the embodiment, the causal structure generated in advance for the substrate processing apparatus 200 of the same model as the substrate processing apparatus 200 of the observation system is used as the general-purpose structure. In step S102, the controller 101 reads, from the storage 102, the parameters that include the weight of the edge and the confidence interval for the weight with respect to the general-purpose structure.

The controller 101 sets a pre-constraint based on the parameters of the general-purpose structure read from the storage 102 (step S103). Since the parameters of the general-purpose structure include the weight of the edge and the confidence interval for the weight, the controller 101 can set the pre-constraint based on these parameters. For example, when the weight of the edge in the general-purpose structure is w0, the confidence interval is ±α, and the weight of the individual structure to be obtained is w, a loss described by abs(w0−w)/α can be set as the pre-constraint. The loss is not limited to the above formula, and a significant difference from a pre-distribution of the weight may be set as the loss.

The controller 101 uses the observed data acquired in step S101 to execute training in which the prior constraint is imposed, set in step S103, thereby deriving the causal structure of the observation variable group in the observation system (step S104). The controller 101 uses the causal search algorithm to search for the causal relationship between the observation variables by imposing the pre-constraint, thereby deriving a causal structure of the entire observation variables. The pre-constraint may allow generation of a new edge on a condition that the causal structure holds directed acyclicity. By executing training that allows the addition of an edge, new knowledge can be obtained when new conditions are added, or structural changes including unexpected changes can be learned and visualized.

For example, in a case of using the DirectLiNGAM algorithm, the controller 101 optimizes the coefficient of linear regression by repeating the regression analysis and the evaluation for the independence between the regression residuals, assuming that there is linearity between the observation variables, that the causal structure has acyclicity, that the probability distribution of the exogenous variable is a non-Gaussian distribution, and that different exogenous variables are independent of each other. The controller 101 generates the directed acyclic graph by drawing an edge between nodes based on the optimized coefficient. Accordingly, a causal structure among observation variables, in which edges from a plurality of nodes having collinearity may be mixed, can be obtained.

After the causal structure is derived in step S104, edge pruning may be performed. That is, the controller 101 may detect edges drawn from a plurality of other nodes having collinearity with respect to one node based on the causal structure derived in step S104, and when corresponding edges exist, in order to add a constraint condition that prohibits edges from being drawn from a plurality of observation variables having collinearity to one observation variable at the same time, the controller 101 may continue the training for the causal search after designating edges other than the edge with the highest accuracy as prohibited edges. By performing the edge pruning, misidentification of an edge can be prevented, and a more reliable causal structure can be learned.

The controller 101 outputs the derived causal structure (step S105). The controller 101 may cause the display 105 to display the derived causal structure or may notify the user terminal via the communicator 103.

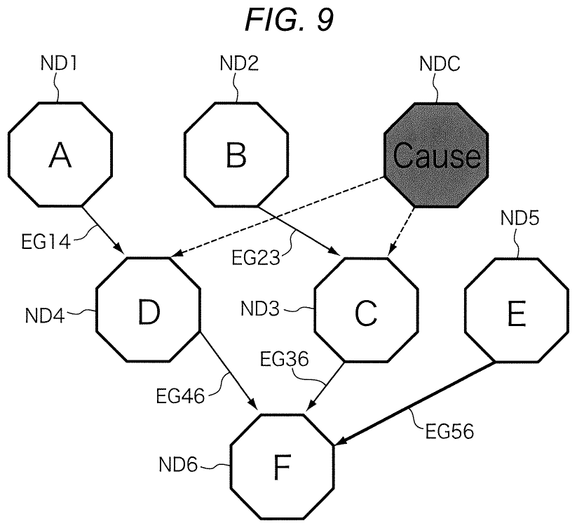

FIG. 8 is a schematic diagram illustrating an example of displaying the causal structure obtained through the additional training. When the additional training is performed while allowing generation of a new edge, a new edge may be added from the general-purpose structure. The example of FIG. 8 illustrates a state where an edge EG13 has been added as a result of performing the additional training using the causal structure illustrated in FIG. 3 as the general-purpose structure. In the example of FIG. 8, the edge EG56 in which the weight of the edge changes by the error or more is illustrated by a thick line. When there is no change in the apparatus or the process, it is considered that there is no addition or loss of an edge or no variation more than an error of a weight. However, when these variations are observed through the additional training, it can be recognized that there is an abnormality in the apparatus or a variation in the mechanism itself, and can be used for an investigation and the like of a cause.

As described above, in Embodiment 1, the causal structure of the observation system can be derived based on the observed data obtained from the observation system, using the general-purpose structure obtained in the substrate processing apparatus 200 of the reference system. In Embodiment 1, since the additional training based on the general-purpose structure is performed, the causal structure can be derived based on a small amount of observed data obtained from the observation system, so that the efficiency of the training can be improved.

### Embodiment 2

In Embodiment 2, a configuration will be described in which a causal structure (general-purpose structure) that has been learned is captured, and an unknown disturbance factor is estimated based on training using new observed data.

The overall configuration of the system and the internal configuration of the information processing apparatus 100 are the same as those in Embodiment 1, and thus descriptions thereof will be omitted.

FIG. 9 is a schematic diagram illustrating an example of the causal structure when a disturbance factor is generated. When the causal structure including the nodes ND1 to ND6 as illustrated in FIG. 9 is obtained by the causal search, only the node ND1 is connected to the upstream side of the node ND4, and thus the observation variable D of the node ND4 is to be determined by only the observation variable A of the node ND1. Similarly, only the node ND2 is connected to the upstream side of the node ND3, and thus the observation variable C of the node ND3 is to be determined by only the observation variable B of the node ND2.

However, when variations in the observation variables of the nodes ND4 and ND3 that are to be determined only by the observation variables A and B of the nodes ND1 and ND2 cannot be clearly described only by the observation variables A and B, it is estimated that there is a variation factor. When it is estimated that there is a variation factor, elements that cannot be described are extracted and defined as disturbance nodes to complement the causal structure. The example of FIG. 9 illustrates a state where a node NDC is complemented as a disturbance node with respect to the nodes ND3 and ND4.

It is assumed that causes having collinearity are common, a merge may be performed to determine that differences from the observation variables A and B to the observation variables D and C are generated due to the same cause. Accordingly, by visualizing the node representing the cause, it is possible to confirm a common influence, and it is possible to give an indication regarding the causal investigation.

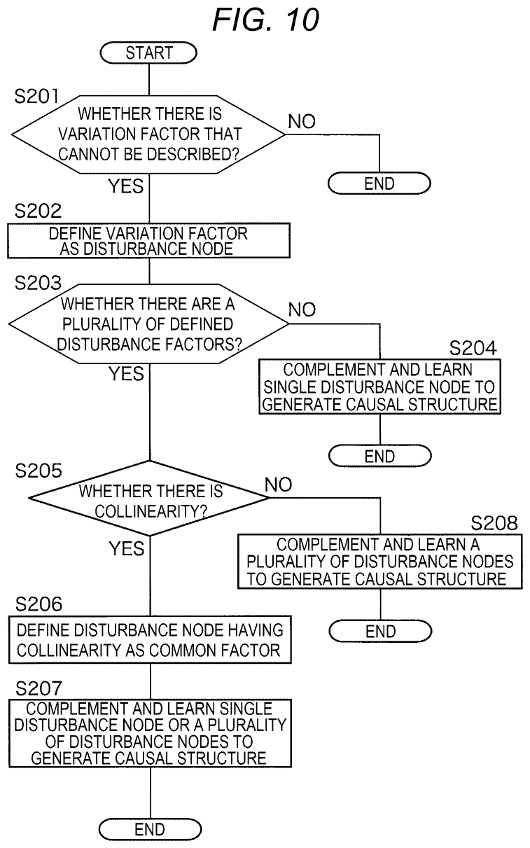

FIG. 10 is a flowchart illustrating a procedure for estimating an unknown disturbance. The controller 101 of the information processing apparatus 100 derives a causal structure through the same procedure as that in Embodiment 1, and determines whether there is a variation factor that cannot be described from the derived causal structure (step S201). For example, in a case where the causal structure as illustrated in FIG. 9 is obtained, it is possible to obtain knowledge that the observation variables D and C vary when the observation variables A and B vary. However, in an actual experiment, it can be determined that there are some variation factors when the observation variables D and C do not vary even when the observation variables A and B vary. When it is determined that there is no variation factor (S201: NO), the controller 101 ends the processing according to the flowchart.

When it is determined that there is a variation factor that cannot be described from the derived causal structure (S201: YES), the controller 101 defines the variation factor as a disturbance node (step S202).

The controller 101 determines whether there are a plurality of defined disturbance nodes (step S203). When it is determined that there is one defined disturbance node (S203: NO), the controller 101 complements and learns a single disturbance node to generate a causal structure that includes the single disturbance node (step S204).

When it is determined that there are a plurality of defined disturbance nodes (S203: YES), the controller 101 determines whether there is collinearity between the disturbance nodes (step S205). When it is determined that there is collinearity (S205: YES), the controller 101 collects the disturbance nodes having collinearity into one node and defines the disturbance nodes as a common factor (step S206). The controller 101 complements and learns a single disturbance node or the plurality of disturbance nodes to generate a causal structure that includes the single disturbance node or the plurality of disturbance nodes (step S207).

When it is determined in step S205 that there is no collinearity between the disturbance nodes (S205: NO), the controller 101 complements and learns the plurality of disturbance nodes to generate a causal structure that includes the plurality of disturbance nodes (step S208).

As described above, in Embodiment 2, by visualizing the disturbance nodes, it is possible to confirm a common influence, and it is possible to give the user an indication regarding the causal investigation.

An object of the disclosure is to provide a computer program, an information processing apparatus, and an information processing method capable of deriving a causal structure of an observation variable group in an observation system based on a causal structure that is a reference.

According to the disclosure, the causal structure of the observation variable group in the observation system can be derived based on the causal structure that is a reference.

The features described in each embodiment can be combined with each other. In addition, the independent and dependent claims set forth in the claims can be combined with each other in any and all combinations, regardless of the reciting format. Further, the claims use a format of describing claims that recite two or more other claims (multi-claim format). However, the disclosure is not limited thereto. The claims may also be described using a format of multi-claims reciting at least one multi-claim format or multi-claim (multi-multi claims).

The embodiments disclosed herein are exemplary in all respects and are required to be considered to be not restrictive embodiments. The scope of the present disclosure is indicated by the scope of the aspects, not the meaning described above, and is intended to include meanings equivalent to the scope of the aspects and all changes within the scope.

For example, in the embodiment, the substrate processing apparatus 200 has been described as an example of a reference system and an observation system. The observation system to be monitored is not limited to the substrate processing apparatus 200, and may be a manufacturing apparatus in which any manufacturing process of electric appliances, chemical industrial products, pharmaceutical products, foods, chemical industrial products, and the like is executed. Further, the reference system and the observation system are not limited to the apparatus or the system in which any manufacturing process is performed, and may be any system in which a living environment, an economic activity, a weather environment, and the like of a person are combined as appropriate.

Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The scope of the invention is indicated by the appended claims, rather than the foregoing description.

1. A non-transitory computer-readable medium storing executable instructions, which when executed by circuitry, cause the circuitry to perform a method, the method comprising:
acquiring observed data corresponding to a plurality of types of observation variables from an observation system;
setting a pre-constraint based on a causal structure of a variable group in a reference system; and
deriving a causal structure of an observation variable group in the observation system by executing training in which the prior constraint is imposed, using the acquired observed data.

2. The non-transitory computer-readable medium according to claim 1, wherein
the causal structure of the reference system is a causal structure generated in advance based on knowledge of a user, and
the method further includes
acquiring a parameter of the causal structure, and
setting the pre-constraint based on the acquired parameter.

3. The non-transitory computer-readable medium according to claim 1, wherein
the causal structure of the reference system is a causal structure derived in advance based on the observed data obtained by observing the reference system,
the method further includes
acquiring a parameter of the causal structure, and
setting the pre-constraint based on the acquired parameter.

4. The non-transitory computer-readable medium according to claim 1, wherein
the causal structure of the reference system is a causal structure generated based on knowledge of a user, and
the method further includes
acquiring information on the causal structure and the observed data obtained by observing the reference system,
correcting the causal structure based on the acquired observed data, and
setting the pre-constraint based on a parameter of the corrected causal structure.

5. The non-transitory computer-readable medium according to claim 1, where in the method further includes:
generating a directed acyclic graph representing the causal structure of the observation variable group using nodes representing the observation variables and an edge representing a causal relationship between the nodes; and
outputting the generated directed acyclic graph.

6. The non-transitory computer-readable medium according to claim 5, wherein the method further includes:
adding a node for displaying a functional form between nodes that are nonlinear when the causal structure of the observation system has nonlinearity.

7. The non-transitory computer-readable medium according to claim 5, wherein the method further includes:
setting a loss according to a confidence interval for a weight between the nodes as the pre-constraint.

8. The non-transitory computer-readable medium according to claim 7, wherein
the confidence interval is set as a numerical range that reflects a probability distribution of the weight.

9. The non-transitory computer-readable medium according to claim 5, wherein
the pre-constraint allows generation of a new edge on a condition that the causal structure holds directed acyclicity.

10. The non-transitory computer-readable medium according to claim 5, wherein the method further includes:
comparing a weight of an edge in the causal structure of the reference system with a weight of an edge in the causal structure of the observation system derived from the training; and
determining that an abnormality in the observation system is detected when the weight of the edge changes by an error or more due to the training.

11. The non-transitory computer-readable medium according to claim 1, wherein the method further includes:
estimating, based on the observed data of the observation system, a disturbance factor that is not included in the causal structure of the reference system.

12. The non-transitory computer-readable medium according to claim 1, wherein
the reference system is a first substrate processing apparatus, and
the observation system is a second substrate processing apparatus of a same type as the first substrate processing apparatus.

13. An information processing apparatus comprising:
controller circuitry, wherein
the controller circuitry is configured to
acquire observed data corresponding to a plurality of types of observation variables from an observation system,
set a pre-constraint based on a causal structure of a variable group in a reference system, and
derive a causal structure of an observation variable group in the observation system by executing training in which the prior constraint is imposed, using the acquired observed data.

14. An information processing method comprising:
acquiring observed data corresponding to a plurality of types of observation variables from an observation system;
setting a pre-constraint based on a causal structure of a variable group in a reference system; and
deriving a causal structure of an observation variable group in the observation system by executing training in which the prior constraint is imposed, using the acquired observed data.

15. The non-transitory computer-readable medium according to claim 1, wherein
the causal structure of the reference system is a causal structure generated in advance based on knowledge of a user.

16. The non-transitory computer-readable medium according to claim 1, wherein
the causal structure of the reference system is a causal structure derived in advance based on the observed data obtained by observing the reference system.

17. The non-transitory computer-readable medium according to claim 1, wherein
the causal structure of the reference system is a causal structure generated based on knowledge of a user, and
the method further includes
acquiring information on the causal structure and the observed data obtained by observing the reference system, and
correcting the causal structure based on the acquired observed data.

18. The non-transitory computer-readable medium according to claim 1, where in the method further includes:
generating a directed acyclic graph representing the causal structure of the observation variable group using nodes representing the observation variables and an edge representing a causal relationship between the nodes.

19. The non-transitory computer-readable medium according to claim 5, wherein the method further includes:
comparing a weight of an edge in the causal structure of the reference system with a weight of an edge in the causal structure of the observation system derived from the training.

20. The non-transitory computer-readable medium according to claim 1, wherein
the reference system is a first substrate processing apparatus.
